(19) United States
(12) Patent Application Publication
(10) Pub. No.: US 2026/0254099 A1
(43) Pub. Date: Aug. 27, 2026

(54) LENSED SECTOR-SPLITTING MULTIBAND BASE STATION ANTENNAS WHERE THE NUMBER OF BEAMS PER FREQUENCY BAND IS NOT RELATED BY THE FREQUENCY RATIO BETWEEN THE FREQUENCY BANDS

(71) Applicant: Outdoor Wireless Networks LLC, Richardson, TX (US)

(72) Inventors: Martin L. Zimmerman, Chicago, IL (US); Xiangyang Ai, Plano, TX (US)

(21) Appl. No.: 19/161,767

(22) PCT Filed: Feb. 22, 2024
(86) PCT No.: PCT/US2024/016803

§ 371 Date: Sep. 3, 2025

Related U.S. Application Data
(60) Provisional application No. 63/452,185, filed on Mar. 15, 2023.

(51) Int. Cl. H01Q 1/24; H01Q 5/30; H01Q 15/14; H01Q 19/10

(52) U.S. Cl. CPC H01Q 1/246; H01Q 5/30; H01Q 15/14; H01Q 19/10

(57) ABSTRACT

Multibeam base station antennas include an RF lens and a reflector having first and second panels. A first lower frequency band array that includes a first lower frequency band radiating element is mounted on the first panel. A second lower frequency band array that includes a second lower frequency band radiating element is mounted on the second panel. A first higher frequency band array that includes a first plurality of higher frequency band radiating elements is mounted on the first panel and a second higher frequency band array that includes a second plurality of higher frequency band radiating elements is mounted on the second panel. The first plurality of higher frequency band radiating elements are mounted in first and second columns, and the second plurality of higher frequency band radiating elements are mounted in third and fourth columns.

### CROSS-REFERENCE TO RELATED APPLICATION

The present application claims priority under 35 U.S.C. § 119 to U.S. Provisional Patent Application Ser. No. 63/452,185, filed Mar. 15, 2023, the entire content of which is incorporated herein by reference as if set forth in its entirety.

### BACKGROUND

The present invention generally relates to wireless communications and, more particularly, to lensed antennas that are suitable for use in cellular and various other types of communications systems.

Cellular communications systems are well known in the art. In a typical cellular communications system, a geographic area is divided into a series of regions that are referred to as “cells” which are served by respective base stations. Each base station includes baseband equipment, radios and base station antennas that are configured to provide two-way radio frequency (“RF”) communications with subscribers that are positioned throughout the cell served by the base station. The base station antennas are often mounted on a tower or other raised structure, with the radiation pattern (“antenna beam”) that is generated by each antenna directed outwardly to serve a respective sector. Typically, a base station antenna includes multiple phase-controlled arrays of radiating elements, with the radiating elements arranged in vertically-extending columns that are referred to as “linear arrays.” Herein, “vertical” refers to a direction that is generally perpendicular relative to the plane defined by the horizon. References will also be made herein to the “azimuth” plane, which refers to a horizontal plane that bisects the base station antenna that is parallel to the plane defined by the horizon.

Typically, each base station antenna will include multiple linear arrays of radiating elements that operate, for example, using second generation (“2G”), third generation (“3G”) or fourth generation (“4G”) cellular network protocols. The linear arrays may be “perfect” columns of radiating elements where all of the radiating elements are aligned along a vertically-extending axis, or may be “staggered” columns in which some of the radiating elements are staggered horizontally in order to reduce (narrow) the half power beamwidth of the antenna beams generated by the linear arrays in the azimuth plane (“azimuth HPBW”). Most modern base station antennas include both “low-band” linear arrays of radiating elements that support 2G/3G/4G service in some or all of the 617-960 MHz frequency band and “mid-band” linear arrays of radiating elements that support 2G/3G/4G service in some or all of the 1427-2690 MHz frequency band. Base station antennas that support service in multiple frequency bands (e.g., the low-band and the mid-band) are typically referred to as “multiband antennas.”

The above-described linear arrays are typically formed using dual-polarized radiating elements. The use of dual-polarized radiating elements allows each linear array to transmit and receive RF signals at two orthogonal polarizations. A linear array that is formed using dual-polarized radiating elements is coupled to two ports of a radio (one port for each polarization). A first RF signal that is to be transmitted by a linear array of the antenna is passed from, for example, a first radio port to a first feed network of the antenna where it is divided into a plurality of sub-components, with each sub-component fed to the first polarization radiators of respective subsets of radiating elements in the linear array (typically each sub-component is fed to the first polarization radiators of between one and three radiating elements). The sub-components of the RF signal are transmitted through the first polarization radiators to generate a first polarization antenna beam that covers a generally fixed coverage area. A second RF signal that is to be transmitted by the same linear array of the antenna is passed from, for example, a second radio port to a second feed network of the antenna where it is divided into a plurality of sub-components, with each sub-component fed to the second polarization radiators of the respective subsets of radiating elements in the linear array. The sub-components of the RF signal are transmitted through the second polarization radiators to generate a second polarization antenna beam that also covers the fixed coverage arca. This allows the linear array to be used to support multi-input-multi-output (“MIMO”) communications (here 2×MIMO communications).

Most base station antennas that support 2G/3G/4G include linear arrays that are designed to generate static antenna beams that provide coverage to a fixed coverage area. However, some 3G and 4G base station antennas may alternatively or additionally include multicolumn “beamforming” arrays of radiating elements that (in conjunction with a beamforming radio) can dynamically generate much narrower, and hence higher gain, antenna beams that can be electronically scanned across a fixed coverage area. In addition, most cellular operators are in the process of upgrading their networks to support fifth generation (“5G”) cellular service. 5G cellular service is, for the most part, implemented in higher frequency bands, such as some or all of the 3.1-4.2 GHz and/or the 5.1-5.8 GHz “high-band” frequency bands. Multicolumn beamforming arrays are widely used in 5G base station antennas.

Most cells in a typical cellular communication system are divided into a plurality of “sectors” in order to increase the communications capacity of the cells. When a sector approach is used, a separate base station antenna provides coverage (service) to each sector. A common base station configuration is the three-sector configuration in which a cell is divided into three 120° “sectors” in the azimuth plane. In a three-sector configuration, three base station antennas are provided at each cell, with each antenna providing coverage to a respective 120° sector in the azimuth plane so that full 360° coverage is provided. In a three-sector configuration, the antenna beams generated by each linear array typically have an azimuth HPBW of about 65°. Unless noted otherwise, references to an azimuth HPBW of an antenna beam refer to the average azimuth HPBW over the operating frequency band of the array of radiating elements that form the antenna beam (since the azimuth HPBW will vary with frequency).

In order to further increase capacity, some cells employ so-called “sector-splitting” techniques where each 1200 sector is further subdivided into two, three or more sub-sectors. Splitting each 120° sector into multiple smaller sub-sectors (e.g., 60° sub-sectors, 40° sub-sectors, etc.) increases system capacity because each antenna can service a smaller area and therefore provide higher antenna gain. In sector-splitting applications, a single multibeam antenna is typically used for each 120° sector. The multibeam antenna generates two or more antenna beams within the same frequency band that point in different directions with each antenna beam providing service to a sub-sector of the 120° sector.

One technique for generating multiple antenna beams in the same frequency band from a single base station antenna is to include an RF lens in the base station antenna. As noted above, most radiating elements for base station antennas are designed to have an azimuth HPBW of about 65°, as such radiating elements generate antenna beams that provide good service to a 120° sector in the azimuth plane. If the antenna beams generated by linear arrays of such radiating elements are passed through an RF lens, such as a cylindrical RF lens, then the RF lens acts to focus the RF energy in the azimuth plane. Multiple linear arrays of radiating elements are positioned behind the RF lens, with the pointing direction of each linear array being at the middle of the respective sub-sectors. For example, for a tri-beam application, the base station antenna will include three linear arrays of radiating elements that are positioned behind an RF lens and arranged to point at angles of about −400°, 0° and 40° in the azimuth plane. The RF lens may narrow the azimuth HPBW of the antenna beams generated by each linear array to about 20°. In this fashion, a single base station antenna can generate three antenna beams (in the same frequency band) that provide service to three respective 40° sub-sectors in the azimuth plane. U.S. Patent Publication No. 2015/0091767 (“the '767 publication”) describes a conventional lensed multibeam sector-splitting base station antenna that can be used to divide a 120° sector into three sub-sectors. The entire content of the '767 publication is incorporated herein by reference as if set forth in its entirety.

FIG. 1A is a simplified partially-exploded perspective view of the lensed base station antenna 1 that is disclosed in the '767 publication, and FIG. 1B is a cross-sectional view taken along a transverse cross-section of the base station antenna 1.

As shown in FIGS. 1A and 1B, the lensed multibeam base station antenna 1 includes three linear arrays 20-1, 20-2, 20-3 of mid-band dual-polarization radiating elements 22. The radiating elements 22 are mounted on a backplane 10. The antenna 1 further includes a cylindrical RF lens 40. The backplane 10 extends the full vertical length of the antenna 1. Opposed transverse edges of the backplane 10 are bent forwardly as can be seen in FIG. 1B so that the backplane 10 comprises three planar panels 12-1, 12-2, 12-3 that define a trench-like cavity behind the cylindrical RF lens 40. By bending the backplane 10 into three planar panels 12-1, 12-2, 12-3, all of the radiating elements 22 may point toward a central longitudinal axis of the cylindrical RF lens 40. The outer panels 12-1, 12-3 may connect to the inner panel 12-2 at interior angles of about 40° and −40 °, respectively. The antenna 1 also includes a radome 50, end caps 60. input/output ports 70 and a tray 80. When the antenna 1 is mounted for use, the central longitudinal axis of the cylindrical RF lens 40 extends in the vertical direction, the azimuth plane is perpendicular to the central longitudinal axis of the cylindrical RF lens 40, and the elevation plane is parallel to the central longitudinal axis of the cylindrical RF lens 40.

The cylindrical RF lens 40 focuses the “antenna beams” of the three linear arrays 20 in the azimuth direction. In particular, the cylindrical RF lens 40 shrinks the azimuth HPBW of the respective antenna beams output by the high-band linear arrays 20 from about 65° to about 20°. The panels 12-1 through 12-3 are positioned behind the RF lens 40 so that the arrays 20-1 through 20-3 will generate antenna beams having boresight pointing directions (i.e., the direction where the antenna beam achieves maximum gain) that are directed at the centers of the respective three sub-sectors. Each linear array 20 generates two static antenna beams (one at each polarization) that provide coverage to the three respective sub-sectors.

### SUMMARY

Pursuant to embodiments of the present invention, multiband base station antennas are provided that comprise first through fourth RF ports, an RF lens, a reflector having at least first and second panels that are angled with respect to each other, a first lower frequency band array mounted on the first panel and coupled to the first RF port, the first lower frequency band array including a first lower frequency band radiating element that is positioned to transmit RF signals through the RF lens, a second lower frequency band array mounted on the second panel and coupled to the second RF port, the second lower frequency band array including a second lower frequency band radiating element that is positioned to transmit RF signals through the RF lens, a first higher frequency band array mounted on the first panel and coupled to the third RF port, the first higher frequency band array including a first plurality of higher frequency band radiating elements that are positioned to transmit RF signals through the RF lens, and a second higher frequency band array mounted on the second panel and coupled to the fourth RF port, the second higher frequency band array including a second plurality of higher frequency band radiating elements that are positioned to transmit RF signals through the RF lens. The first plurality of higher frequency band radiating elements are mounted in first and second columns and the second plurality of higher frequency band radiating elements are mounted in third and fourth columns.

In some embodiments, the base station antenna is a sector splitting antenna that is configured to generate static first and second lower frequency band antenna beams that point in different directions and static first and second higher frequency band antenna beams that point in different directions.

In some embodiments, the base station antenna is a sector splitting antenna that is configured to generate a plurality of lower frequency band antenna beams that provide coverage to a first number of distinct sub-sectors in a coverage area of the base station antenna and to generate a plurality of higher frequency band antenna beams that provide coverage to the first number of distinct sub-sectors in the coverage area of the base station antenna.

In some embodiments, the second column and the third column are positioned in between the first lower frequency band array and the second lower frequency-band array.

In some embodiments, one of the higher frequency band radiating elements in the first plurality of higher frequency band radiating elements is mounted within an interior of the first lower frequency band radiating element. In such embodiments, the first lower frequency band radiating element may comprise, for example, a box-dipole radiating element.

In some embodiments, the RF lens is a spherical RF lens. In other embodiments, the RF lens is a cylindrical RF lens.

In some embodiments, the first lower frequency band array is configured to generate a first antenna beam and the first higher frequency band array is configured to generate a second antenna beam, where the base station antenna is configured so that a first percentage of a main lobe of the first antenna beam illuminates the RF lens and a second percentage of a main lobe of the second antenna beam illuminates the RF lens, where the second percentage exceeds the first percentage.

In some embodiments, at least some of the higher frequency band radiating elements in the first plurality of higher frequency band radiating elements surround the first lower frequency band radiating element.

In some embodiments, a total of four of the higher frequency band radiating elements in the first plurality of higher frequency band radiating elements surround the first lower frequency band radiating element.

In some embodiments, a phase center of the four of the higher frequency band radiating elements in the first plurality of higher frequency band radiating elements that surround the first lower frequency band radiating element is aligned with a phase center of the first lower frequency band radiating element in at least one of the azimuth plane and the elevation plane. In some embodiments, a phase center of the four of the higher frequency band radiating elements in the first plurality of higher frequency band radiating elements that surround the first lower frequency band radiating element is aligned with a phase center of the first lower frequency band radiating element in both the azimuth plane and the elevation plane.

In some embodiments, the first lower frequency band array includes the first lower frequency band radiating element and at least one additional lower frequency band radiating element that are arranged in a first vertically-extending column and the second lower frequency band array includes the lower frequency band radiating element and at least one additional lower frequency band radiating element that are arranged in a second vertically-extending column.

In some embodiments, the first plurality of higher frequency band radiating elements comprises higher frequency band radiating elements that are arranged in first through third vertically-extending columns of higher frequency band radiating elements.

Pursuant to additional embodiments of the present invention, multiband base station antennas are provided that comprise first and second RF ports, an RF lens, a first lower frequency band array coupled to the first RF port, the first lower frequency band array including a first lower frequency band radiating element that is positioned to transmit RF signals through the RF lens, and a first higher frequency band array coupled to the second RF port, the first higher frequency band array including a first plurality of higher frequency band radiating elements that are positioned to transmit RF signals through the RF lens. The first lower frequency band array is configured to generate a first antenna beam and the first higher frequency band array is configured to generate a second antenna beam, where the base station antenna is configured so that a first percentage of a main lobe of the first antenna beam illuminates the RF lens and a second percentage of a main lobe of the second antenna beam illuminates the RF lens.

In some embodiments, the base station antenna further comprises third and fourth RF ports, a second lower frequency band array coupled to the third RF port, the second lower frequency band array including a second lower frequency band radiating element that is positioned to transmit RF signals through the RF lens; and a second higher frequency band array coupled to the fourth RF port, the second higher frequency band array including a second plurality of higher frequency band radiating elements that are positioned to transmit RF signals through the RF lens.

In some embodiments, the base station antenna is a sector splitting antenna, and the first lower frequency band array is configured to generate a first static lower frequency band antenna beam that points in a first direction, the second lower frequency band array is configured to generate a second static lower frequency band antenna beam that points in a second direction that is different from the first direction, the first higher frequency band array is configured to generate a first static higher frequency band antenna beam that points in a third direction, and the second higher frequency band array is configured to generate a second static higher frequency band antenna beam that points in a fourth direction that is different from the third direction. In some embodiments, the first direction is the same as the third direction and the second direction is the same as the fourth direction.

In some embodiments, the base station antenna further comprises a reflector having at least first and second panels that are angled with respect to each other, wherein the first lower frequency band array and the first higher frequency band array are mounted to extend forwardly from the first panel, and the second lower frequency band array and the second higher frequency band array are mounted to extend forwardly from the second panel.

In some embodiments, the base station antenna is a sector splitting antenna that is configured to generate a plurality of lower frequency band antenna beams that provide coverage to a first number of distinct sub-sectors in a coverage area of the base station antenna and to generate a plurality of higher frequency band antenna beams that provide coverage to the first number of distinct sub-sectors in the coverage area of the base station antenna.

In some embodiments, one of the higher frequency band radiating elements in the first plurality of higher frequency band radiating elements is mounted within an interior of the first lower frequency band radiating element. In some embodiments, the first lower frequency band radiating element may be a box-dipole radiating element.

In some embodiments, four of the higher frequency band radiating elements in the first plurality of higher frequency band radiating elements define a rectangle and the first lower frequency band radiating element is within the rectangle. In some embodiments, a fifth of the first higher frequency band radiating elements in the first plurality of higher frequency band radiating elements is mounted within an interior of the first lower frequency band radiating element. In some embodiments, a phase center of the four of the higher frequency band radiating elements in the first plurality of higher frequency band radiating elements that surround the first lower frequency band radiating element is aligned with a phase center of the first lower frequency band radiating element in at least one (or both) of the azimuth plane and the elevation plane.

In some embodiments, the first higher frequency band array comprises a multicolumn array of radiating elements.

In some embodiments, the first lower frequency band array includes the first lower frequency band radiating element and at least one additional lower frequency band radiating element that are arranged in a first vertically-extending column and positioned to transmit RF signals through the RF lens, and the second lower frequency band array includes the second lower frequency band radiating element and at least one additional lower frequency band radiating element that are arranged in a second vertically-extending column and positioned to transmit RF signals through the RF lens.

In some embodiments, the first plurality of higher frequency band radiating elements comprises higher frequency band radiating elements that are arranged in at least first and second vertically-extending columns of higher frequency band radiating elements, and the second plurality of higher frequency band radiating elements comprises higher frequency band radiating elements that are arranged in at least third and fourth vertically-extending columns of higher frequency band radiating elements.

In some embodiments, the second and third vertically-extending columns of higher frequency band radiating elements, are positioned in between the first and second first lower frequency band arrays.

In some embodiments, the first lower frequency band array is in between the first and second vertically-extending columns of higher frequency band radiating elements, and the second lower frequency band array is in between the third and fourth vertically-extending columns of higher frequency band radiating elements.

Pursuant to other embodiments of the present invention, multiband, multibeam base station antennas are provided that comprise one or more RF lenses, a plurality of first RF ports, a plurality of second RF ports, a plurality of arrays of first radiating elements, each array of first radiating elements coupled to a respective one of the RF ports in the plurality of first RF ports and including at least one first radiating element, where the first radiating elements are configured to operate in a first frequency band and are positioned to transmit RF signals through the one or more RF lenses, and a plurality of arrays of second radiating elements, each array of second radiating elements coupled to a respective one of the RF ports in the plurality of second RF ports and including a plurality of second radiating elements, where the second radiating elements are configured to operate in a second frequency band and are positioned to transmit RF signals through the one or more RF lenses. A first number of arrays of first radiating elements is the same as a second number of arrays of second radiating elements and each of the arrays of second radiating elements is a multicolumn array of radiating elements.

In some embodiments, the second frequency band encompasses higher frequencies than the first frequency band.

In some embodiments, the base station antenna is configured to generate a first number of antenna beams in the first frequency band and to also generate the first number of antenna beams in the second frequency band.

In some embodiments, each of the arrays of first radiating elements has a different pointing direction and each of the arrays of second radiating elements has a different pointing direction

In some embodiments, each of the plurality of arrays of first radiating elements is configured to generate respective first antenna beams and each of the plurality of arrays of second radiating elements is configured to generate respective second antenna beams, where the base station antenna is configured so that a first percentage of main lobes of the first antenna beams illuminates the RF lens and a second percentage of main lobes of the second antenna beams illuminates the RF lens, where the second percentage exceeds the first percentage.

In some embodiments, the second radiating elements in each of the plurality of arrays of second radiating elements are mounted to define at least first, second and third columns.

In some embodiments, the base station antenna is a sector splitting antenna that is configured to generate a plurality of static first frequency band antenna beams that point in different directions and a plurality of static second frequency band antenna beams that point in different directions.

In some embodiments, the RF lens is a cylindrical RF lens.

Pursuant to still further embodiments of the present invention, base station antennas are provided that comprise an RF lens, a first radiating element that is configured to operate in a first frequency band, where the first radiating element is positioned to transmit RF signals through the RF lens, and a plurality of second radiating elements that are configured to operate in a second frequency band that encompasses higher frequencies than the first frequency band, the plurality of second radiating elements arranged in at least a first sub-array and positioned to transmit RF signals through the RF lens. A phase center of the first sub-array is aligned with a phase center of the first radiating element in at least one of the azimuth plane and the elevation plane.

In some embodiments, the phase center of the first sub-array is aligned with the phase center of the first radiating element in both the azimuth plane and the elevation plane.

In some embodiments, one of the second radiating elements is mounted within an interior of the first radiating element.

In some embodiments, the first radiating element is a box-dipole radiating element.

In some embodiments, the first radiating element is part of an array of first radiating elements that is one of a plurality of arrays of first radiating elements, each array of first radiating elements coupled to a respective first RF port, and the plurality of second radiating elements is part of an array of second radiating elements that is one of a plurality of arrays of second radiating elements, each array of second radiating elements coupled to a respective second RF port.

In some embodiments, the base station antenna is a sector-splitting base station antenna that is configured to sub-divide a coverage area of the base station antenna into a first number of sub-sectors in the first frequency band and to also sub-divide the coverage area of the base station antenna into the first number of sub-sectors in the second frequency band.

In some embodiments, each of the arrays of first radiating elements is configured to generate antenna beams that have different pointing directions.

In some embodiments, the plurality of second radiating elements are mounted to define at least first and second columns.

In some embodiments, the plurality of second radiating elements are mounted to define at least first, second and third columns.

In some embodiments, the first radiating element is configured to generate a first antenna beam and the plurality of second radiating elements are configured to generate a second antenna beam, where the base station antenna is configured so that a first percentage of a main lobe of the first antenna beam illuminates the RF lens and a second percentage of a main lobe of the second antenna beam illuminates the RF lens, where the second percentage exceeds the first percentage.

In some embodiments, the second radiating elements comprise first through fourth second radiating elements that are arranged to define a rectangle.

In some embodiments, the first radiating element is within the rectangle.

In some embodiments, the second radiating elements further comprise a fifth second radiating element that is positioned within the first radiating element.

In some embodiments, a phase center of the first through fourth second radiating elements is aligned with a phase center of the first radiating element in at least one of the azimuth plane and the elevation plane.

Pursuant to yet additional embodiments of the present invention, multiband, multibeam base station antennas are provided that comprise one or more RF lenses, a plurality of arrays of first radiating elements, each array of first radiating elements including at least one first radiating element, where the first radiating elements are configured to operate in a first frequency band and are positioned to transmit RF signals through the one or more RF lenses, and a plurality of arrays of second radiating elements, each array of second radiating elements including a sub-array of second radiating elements that are positioned around one of the first radiating elements in a respective one of the plurality of arrays of first radiating elements, where the second radiating elements are configured to operate in a second frequency band that encompasses higher frequencies that the first frequency band and are positioned to transmit RF signals through the one or more RF lenses.

In some embodiments, each first radiating element comprises a box dipole radiating element.

In some embodiments, at least some of the sub-arrays of second radiating elements includes a second radiating element that is positioned within the footprint of a respective one of the first radiating elements.

In some embodiments, the phase center of a first of the sub-arrays of second radiating elements is aligned with the phase center of one of the first radiating elements in both the azimuth plane and the elevation plane.

In some embodiments, the base station antenna is a sector-splitting base station antenna that is configured to sub-divide a coverage area of the base station antenna into a first number of sub-sectors in the first frequency band and to also sub-divide the coverage area of the base station antenna into the first number of sub-sectors in the second frequency band.

In some embodiments, each sub-array of second radiating elements includes at least four second radiating elements that are mounted to define at least first and second columns. In other embodiments, each sub-array of second radiating elements includes at least five second radiating elements that are mounted to define at least first, second and third columns.

In some embodiments, each sub-array of second radiating elements includes at least four second radiating elements that are arranged to define a rectangle.

### BRIEF DESCRIPTION OF THE DRAWINGS

FIGS. 1A and 1B are a partially-exploded perspective view and a cross-sectional view, respectively, of a conventional lensed base station antenna.

FIG. 2A is a schematic front view of a conventional multiband, multibeam lensed antenna with the radome and lens omitted from the drawing.

FIG. 2B is a schematic end view of the multiband, multibeam lensed antenna of FIG. 2A with the lens included.

FIG. 3A is a schematic front view of a multiband, multibeam lensed antenna according to embodiments of the present invention with the radome removed and the RF lens shown in shadow view.

FIG. 3B is a schematic end view of the multiband, multibeam lensed antenna of FIG. 3A.

FIG. 3C is an enlarged schematic front view of one of the mid-band radiating elements and five of the high-band radiating elements that are included in the base station antenna of FIGS. 3A-3B.

FIG. 3D is a schematic top view of the RF lens and one of the panels of the backplane of the base station antenna of FIGS. 3A-3B that schematically illustrates how the lensed base station antennas according to embodiments of the present invention may generate antenna beams at two different frequency bands that have approximately the same azimuth HPBW after the RF radiation in each frequency band is transmitted through the RF lens.

FIG. 4A is a block diagram of a feed network for the two arrays of lower frequency band radiating elements included in the base station antenna of FIGS. 3A-3C.

FIG. 4B is a block diagram of a feed network for the two arrays of higher frequency band radiating elements included in the base station antenna of FIGS. 3A-3C.

FIGS. 5A-5D are schematic front views of alternative sub-array configurations that can be used in place of the sub-array configuration for the high-band radiating elements used in the base station antenna of FIGS. 3A-3C.

FIG. 6 is a schematic front view of a base station antenna according to further embodiments of the present invention that includes a column of spherical RF lenses instead of a cylindrical RF lens.

FIG. 7 is a schematic front view of a multiband, multibeam lensed antenna with the radome removed that includes a single row of mid-band radiating elements and a single row of sub-arrays of high-band radiating elements.

FIG. 8A is a schematic front view of a multiband, tri-beam lensed base station antenna according to embodiments of the present invention with the radome removed and an RF lens of the antenna shown in shadow view.

FIG. 8B is a schematic end view of the multiband, tri-beam lensed base station antenna of FIG. 8A.

FIG. 9 is a schematic front view of a sector-splitting multiband, multibeam lensed antenna with the radome removed that splits a sector into six sub-sectors.

FIG. 10 is a schematic front view of a multiband, multibeam lensed base station antenna according to embodiments of the present invention that includes different numbers of lower frequency band and higher frequency band arrays.

FIG. 11 is a schematic front view of a building block of a tri-band base station antenna according to further embodiments of the present invention.

FIG. 12 is a front view of a building block of a multiband base station antenna according to still further embodiments of the present invention.

### DETAILED DESCRIPTION

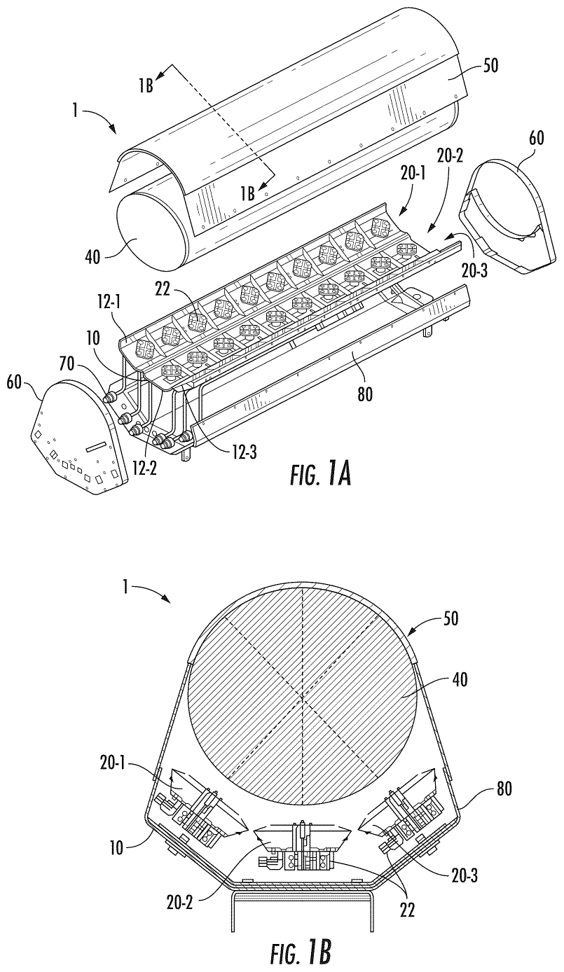

The lensed base station antenna 1 of FIGS. 1A-1B only includes linear arrays 20 of mid-band radiating elements 22. As discussed above, cellular operators are primarily interested in base station antennas that include linear arrays that operate in multiple frequency bands. Unfortunately, it can be challenging to design lensed sector-splitting base station antennas that operate in multiple frequency bands.

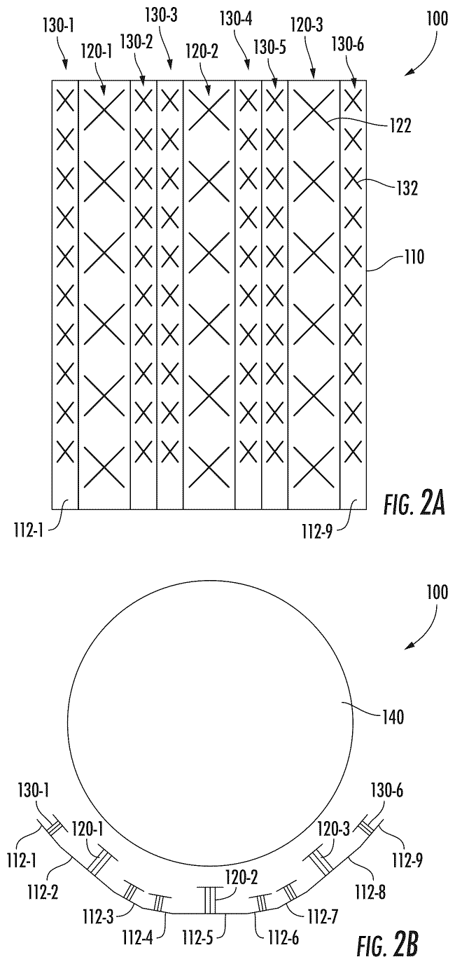

Despite these challenges, lensed sector-splitting base station antennas have been proposed that include linear arrays that operate in multiple frequency bands. For example, U.S. Patent Publication No. 2019/0237874 discloses several multiband lensed base station antennas that perform sector-splitting in the mid-band frequency range and provide a standard sector antenna beam in the low-band frequency range. As another example, FIGS. 2A and 2B illustrate a conventional lensed base station antenna 100 that performs sector-splitting in both the low-band and mid-band frequency ranges. In particular, FIG. 2A is a schematic front view of the multiband, multibeam lensed antenna 100 with a radome and RF lens thereof removed, and FIG. 2B is a schematic end view of the lensed antenna 100 with the RF lens shown.

As shown in FIGS. 2A and 2B, the lensed multibeam base station antenna 100 includes three linear arrays 120-1, 120-2, 120-3 of low-band (694-960 MHz) radiating elements 122 and six linear arrays 130-1 through 130-6 of mid-band (1695-2690 MHz) radiating elements 132. The radiating elements 122, 132 are mounted on a backplane 110. The antenna 100 further includes a cylindrical RF lens 140 (see FIG. 2B). The backplane 110 extends the full vertical length of the antenna 100. The backplane 110 is bent along longitudinally-extending creases as can be seen in FIG. 2B so that the backplane 110 comprises nine planar panels 112-1 through 112-9 that define a trench-like cavity behind the cylindrical RF lens 140. The antenna 100 also includes other conventional features (not shown) such as a radome, end caps, input/output ports, etc.

The three low-band linear arrays 120-1, 120-2, 120-3 are mounted on backplane panels 112-2, 112-5, 112-8, respectively. The six mid-band linear arrays 130-1 through 130-6 are mounted on the respective panels 112-1, 112-3, 112-4, 112-6, 112-7, 112-9. The panels 112 are bent so that each of the low-band linear arrays 120 and each of the mid-band linear arrays 130 point toward a central longitudinal axis of the cylindrical RF lens 140. The low-band arrays 120-1, 120-2, 120-3 may have azimuth boresight pointing directions of about −40°, 0° and 40°, respectively to divide the 120° sector (where the center of the sector is at 0°) served by base station antenna 100 into three sub-sectors in the low-band frequency range. The mid-band arrays 130-1 through 130-6 may have azimuth boresight pointing directions of about −50°, −30°, −10°, 10°, 30° and 50°, respectively to divide the 120° sector served by base station antenna 100 into six sub-sectors in the mid-band frequency range.

The amount that the RF lens 140 narrows the azimuth HPBW of the antenna beams generated by the linear arrays 120, 130 is a function of the frequency of the RF signals. In particular, the RF lens focuses higher frequency RF energy more than lower frequency RF energy with the amount of focusing increasing linearly with increasing frequency. Consequently, the number of antenna beams that are generated by most multiband, multibeam base station antennas at each frequency band is proportional to the diameter of the RF lens in wavelengths. Since the 2200 MHz center frequency of the mid-band operating frequency range of base station antenna 100 is between two and three times (specifically 2.65 times) the 828 MHz center frequency of the low-band operating frequency range thereof (and hence the center wavelength of the mid-band operating frequency range is 2.65 times the center wavelength of the low-band operating frequency range), after passing through the RF lens 140, the azimuth HPBW of the antenna beams generated by the mid-band linear arrays 130 will be less than half the azimuth HPBW of the antenna beams generated by the low-band linear arrays 120. Thus, if the RF lens 140 is sized to reduce the azimuth HPBW of the antenna beams generated by the low-band linear arrays 120 from about 65° to about 20° (which is an appropriate sizing for splitting the 120° sector into three 40° sectors at low-band), then the RF lens 140 will reduce the azimuth HPBW of the antenna beams generated by the mid-band linear arrays 130 from about 65° to about 7.5°. By adjusting the azimuth HPBWs at both frequency bands, antenna beams may be formed that are appropriate for splitting the 120° sector into three approximately 40° sectors at low-band and into six approximately 20° sectors at mid-band.

Cellular network operators would typically prefer that a multiband sector-splitting antenna split the 120° sector into the same number of sub-sectors at each frequency band, as this simplifies capacity planning for the base station. The above-described sector-splitting antenna 100 cannot accomplish this, since the RF lens 140 focuses the mid-band RF radiation more than the low-band RF radiation. Moreover, in some situations, the 4G control channels are used to control both 4G and 5G communications at a base station so that 5G is only used for data transport. In such deployments, the 4G radio sends out control signals that identify user devices and assigns them to cells (and to sub-sectors within a sector of a cell). In order for the control operations to work properly in such deployments, the 4G sub-sectors must be aligned with the 5G sub-sectors.

As one example, there are base station antennas that include both 5G high-band linear arrays that operate in the 3.5 GHz frequency band and 4G mid-band linear arrays that operate in the 1.7-2.7 GHz frequency band, where the 4G radio provides control for both 4G and 5G operations. In this situation, if a multiband antenna is to be designed as a sector-splitting antenna, the same number of sub-sectors must be present at both mid-band and high-band. However, assuming that the mid-band arrays are designed to operate in some portion of the 1.7-2.7 GHz frequency range and the high-band arrays are designed to operate in some portion of the 3.1-4.2 GHz frequency range, an RF lens that was designed to split the sector into six sub-sectors at mid-band would split the sector into 8-10 sub-sectors at high-band. (e.g., 6*3.7 GHz/2.2 GHz =10). However, if the number of sub-sectors is different at mid-band and high-band, the 4G controller could not be used to control the 5G communications. In other words, in situations where the 4G radio provides control of both 4G and 5G operations, sector-splitting can only be performed if the same number of sub-sectors are provided for both the 4G and 5G communications.

Pursuant to embodiments of the present invention, multiband, multibeam sector-splitting base station antennas are provided in which the number of antenna beams generated in the different frequency bands is not based on the ratio of the center frequencies of the two frequency bands. This may be accomplished by designing the higher frequency band arrays to have larger apertures in the azimuth plane than the lower frequency band arrays. In one example implementation of such an antenna, the higher frequency band arrays may be multicolumn arrays of radiating elements. The larger aperture in the azimuth plane provided by the multiple columns acts to narrow the antenna beams generated by the high-band arrays in the azimuth plane and, as a result, the high-band antenna beams under-illuminate the RF lens (e.g., the portion of the main lobe of each antenna beam that is within 3 dB of the peak gain may only pass through a central portion of the RF lens). This effectively makes the RF lens appear smaller to the high-band radiation, and hence the RF lens performs less focusing of the high-band RF radiation. As a result, the base station antenna can be designed so that the mid-band and high-band antenna beams, after passing through the RF lens, have approximately the same azimuth HPBW, allowing a sector to be split into the same number of sub-sectors at both the mid-band and high-band frequency bands. The same techniques may be used for other combinations of frequency bands (e.g., low-band and mid-band or low-band and high-band). Moreover, when the RF lens is under-illuminated by an RF signal, the sidelobe levels of the antenna beam exiting the RF lens may be suppressed. Thus, the techniques according to embodiments of the present invention may also provide improved antenna beam shape and gain at the higher frequency band.

The above-described approach is non-intuitive, as the problem with multiband sector splitting antennas is that the higher frequency band antenna beams are narrowed more than the lower frequency band antenna beams. Despite this, the base station antennas according to embodiments of the present invention include arrays that generate narrower than normal antenna beams in the azimuth plane at the higher frequency band, which on its face appears to exacerbate the problem rather than solve it. However, since the narrower high-band antenna beams illuminate less of the RF lens, the azimuth HPBW of the high-band antenna beams as they exit the RF lens is actually broader than normal.

In some embodiments, at least some of the lower-band radiating elements are implemented as box-dipole radiating elements. This allows some of the higher-band radiating elements to be mounted within the interior of respective ones of the lower-band radiating elements. Moreover box dipole radiating elements have an advantage in that each box dipole radiating element may be viewed as being a small array. As such, the azimuth (and elevation) beamwidths of a box dipole element may scale with frequency; thus, the azimuth and elevation HPBWs narrow across the operating frequency range of the box dipole. For a broad operating frequency band (e.g., 1.695-2.690 GHz) the RF lens is noticeably larger in wavelengths at 2.690 GHz than at 1.695 GHz. But since the HPBW of the box dipole decreases with increasing frequency, the pattern of the box dipole will progressively under-illuminate the RF lens as the frequency increases causing the antenna beam emitted at the output of the RF lens to have a stable HPBW across the entire operating frequency range of the box dipole. The higher frequency band radiating elements may be arranged in a wide variety of configurations that are designed to generate antenna beams having narrower azimuth beamwidths. In example embodiments, multicolumn arrays having two or three columns of higher-band radiating elements may be provided that generate antenna beams having narrowed azimuth beamwidths that under-illuminate the RF lens. In some embodiments, a plurality of the higher frequency band radiating elements may be arranged around the periphery of some or all of the lower frequency band radiating elements. When box-dipole radiating elements are used to implement the lower frequency band radiating elements, one of the higher frequency band radiating elements may also be positioned within the interior of the box-dipole radiating element.

In some embodiments of the present invention, multiband, multibeam base station antennas are provided that include first through fourth RF ports, an RF lens and a reflector having at least first and second panels that are angled with respect to each other. A first lower frequency band array is mounted on the first panel and coupled to the first RF port, the first lower frequency band array including a first lower frequency band radiating element that is positioned to transmit RF signals through the RF lens. A second lower frequency band array is mounted on the second panel and coupled to the second RF port, the second lower frequency band array including a second lower frequency band radiating element that is positioned to transmit RF signals through the RF lens. A first higher frequency band array is mounted on the first panel and coupled to the third RF port, the first higher frequency band array including a first plurality of higher frequency band radiating elements that are positioned to transmit RF signals through the RF lens. Finally, a second higher frequency band array is mounted on the second panel and coupled to the fourth RF port, the second higher frequency band array including a second plurality of higher frequency band radiating elements that are positioned to transmit RF signals through the RF lens. The first plurality of higher frequency band radiating elements are mounted in first and second columns, and the second plurality of higher frequency band radiating elements are mounted in third and fourth columns.

In other embodiments, multiband, multibeam base station antennas are provided that comprise first and second RF ports, an RF lens, a first lower frequency band array coupled to the first RF port, and a first higher frequency band array coupled to the second RF port. The first lower frequency band array includes a first lower frequency band radiating element that is positioned to transmit RF signals through the RF lens. The first higher frequency band array includes a first plurality of higher frequency band radiating elements that are also positioned to transmit RF signals through the RF lens. The first lower frequency band array is configured to generate first antenna beams having “3 dB sections” that illuminate a first percentage of the RF lens, and the first higher frequency band array is configured to generate second antenna beams having 3 dB sections that illuminate a second percentage of the RF lens that is less than the first percentage. Herein, a “3 dB section” of an antenna beam refers to the portion of the antenna beam that has a gain that is within 3 dB of the peak gain of the antenna beam.

In still other embodiments, multiband, multibeam base station antennas are provided that, include one or more RF lenses, a plurality of first RF ports, a plurality of second RF ports, a plurality of arrays of first radiating elements, and a plurality of arrays of second radiating elements. Each array of first radiating elements is coupled to a respective one of the first RF ports and includes at least one first radiating element that is configured to operate in a first frequency band and is positioned to transmit RF signals through the one or more RF lenses. Each array of second radiating elements is coupled to a respective one of the second RF ports and includes a plurality of second radiating elements that are configured to operate in a second frequency band and are positioned to transmit RF signals through the one or more RF lenses. The base station antenna has the same number of arrays of first radiating elements and of second radiating elements. Moreover, each of the arrays of second radiating elements is a multicolumn array of radiating elements.

In yet additional embodiments, base station antennas are provided that comprise a RF lens, a first radiating element that is configured to operate in a first frequency band, where the first radiating element is positioned to transmit RF signals through the RF lens, and a plurality of second radiating elements that are configured to operate in a second frequency band that encompasses higher frequencies than the first frequency band, the plurality of second radiating elements arranged in at least a first sub-array and positioned to transmit RF signals through the RF lens. A first phase center of the first sub-array is aligned with a second phase center of the first radiating element in at least one of the azimuth plane and the elevation plane.

According to still further embodiments of the present invention, multiband, multibeam base station antennas are provided that comprise one or more RF lenses, a plurality of arrays of first radiating elements, each array of first radiating elements including at least one first radiating element, where the first radiating elements are configured to operate in a first frequency band and are positioned to transmit RF signals through the one or more RF lenses, and a plurality of arrays of second radiating elements, each array of second radiating elements including a sub-array of second radiating elements that are positioned around one of the first radiating elements in a respective one of the plurality of arrays of first radiating elements, where the second radiating elements are configured to operate in a second frequency band that encompasses higher frequencies that the first frequency band and are positioned to transmit RF signals through the one or more RF lenses.

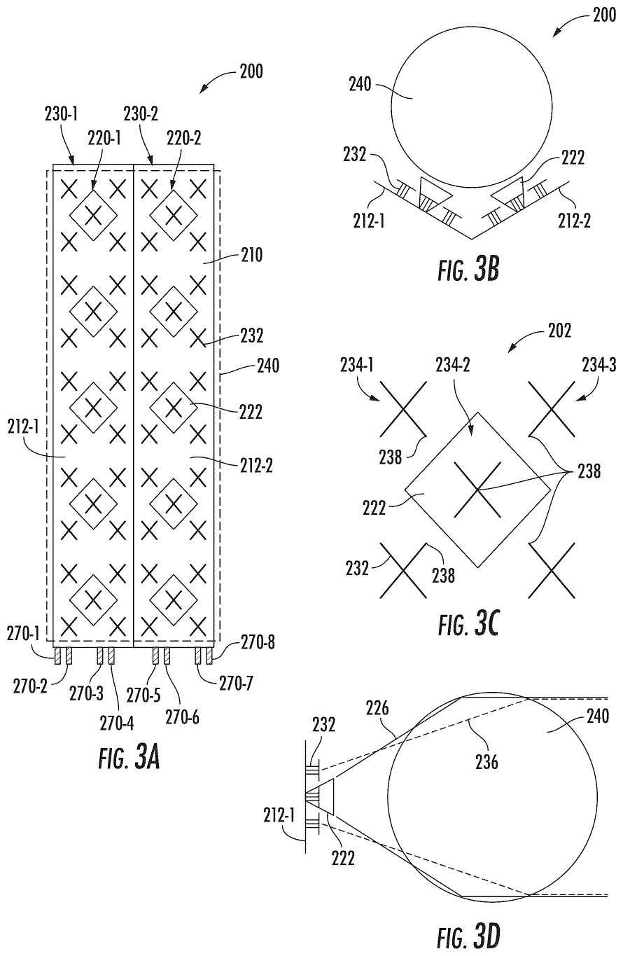

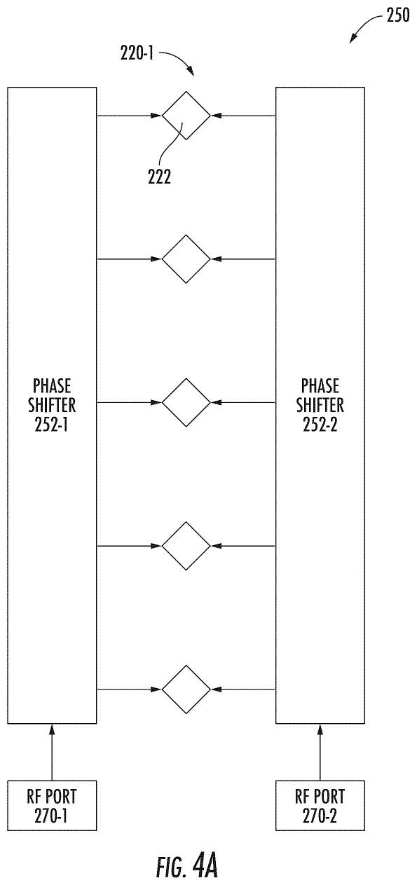

Embodiments of the present invention will now be discussed in greater detail with reference to FIGS. 3A-11.

FIG. 3A is a schematic front view of a lensed multiband, multibeam lensed antenna 200 according to embodiments of the present invention with the radome removed and an RF lens thereof shown in shadow view. FIG. 3B is a schematic end view of the multiband, multibeam lensed antenna 200 of FIG. 3A. FIG. 3C is an enlarged schematic front view of a building block 202 of base station antenna 200 that includes one mid-band radiating element and five high-band radiating elements.

As shown in FIGS. 3A-3B. the base station antenna 200 includes a backplane 210, an RF lens 240 and a first through eighth RF ports 270-1 through 270-8 (only shown in FIG. 3A). The backplane 210 has first and second planar panels 212-1, 212-2 that are angled with respect to each other. The backplane 210 may comprise a piece of sheet metal that is bent into the shape shown in FIGS. 3A-3B. The first and second planar panels 212-1, 212-2 may meet to define an interior angle of about 120° degrees. The backplane 210 may act as both a reflector for the antenna 200 and as a ground plane for the radiating elements mounted thereon. Accordingly, the backplane 210 may also be referred to as a reflector herein.

The RF lens 240 has a cylindrical shape. A longitudinal axis of the RF lens 240 may extend generally in the vertical direction when the base station antenna 200 is mounted for normal use. The RF lens 240 is mounted in front of the backplane 210. In some embodiments, the RF lens 240 may have a substantially homogeneous dielectric constant. This is particularly true for sector splitting antennas that divide the sector into two or three sub-sectors. If the RF lens 240 has a substantially homogeneous dielectric constant on the order of about 1-3-1.7, the RF lens 240 may have a diameter of about 200-220 mm.

In other embodiments, the RF lens 240 may be a step approximation of a Luneberg lens in some embodiments. A Luneberg lens is a known type of RF lens that has a dielectric constant that continually decreases with increasing distance from a center of the lens. In particular, a Luneberg lens has a dielectric constant that conforms to the following formula:

$$Dk = 2 * [ 1 - {( r / R )}^{2} ] \qquad ( 1 )$$

where Dk is the dielectric constant, R is the radius of the Luneberg lens and r is a particular location along the radius R.

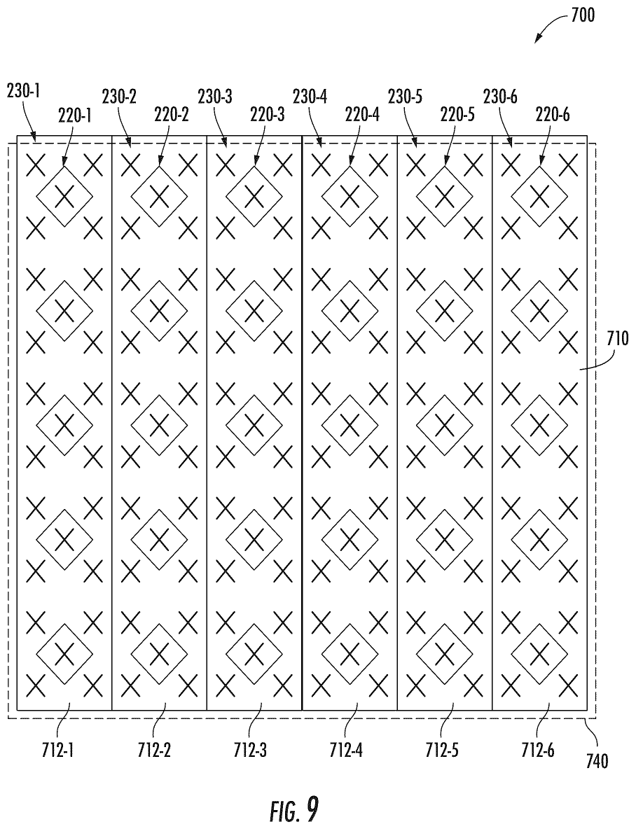

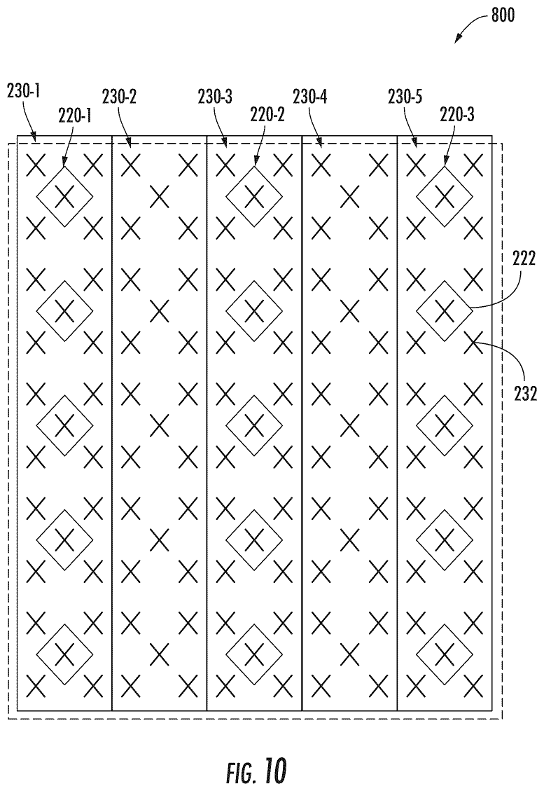

Luneberg lens may have various advantages as compared to other types of RF lenses including, for example the fact that an ideal Luneberg lens has a perfect focal point. Luneberg lenses are typically implemented as step approximations of an ideal Luneberg lens, with three to six steps being common. Luneberg lens may be particularly useful in applications where a sector is divided into a rather large number of sub-sectors such as four, five, six or more. For example, FIG. 9 of the present application discloses a sector-splitting antenna that splits a sector into six sub-sectors and is designed to emit RF energy in the 1.7-2.7 GHz and 3.7-4.0 GHz frequency bands. The RF lens for this antenna may, for example, include a cylindrical Luneberg lens.

While a Luneberg lens may be used in some cases, it will be appreciated that embodiments of the present invention are not limited thereto. For example, in other embodiments the RF lens 240 may be formed of a dielectric material that has a generally homogeneous dielectric constant throughout the lens structure. The use of a single dielectric material in the RF lens 240 may make the lens easier and less expensive to manufacture as compared to a Luneburg lens. In some embodiments, the dielectric material(s) used to form the RF lens may comprise so-called artificial dielectric materials that include both dielectric materials and metal that are mixed together to provide a material having a relatively high dielectric constant. The RF lens 240 may. in some embodiments, include a shell such as a hollow, lightweight structure that holds the dielectric material in place.

As shown in FIGS. 3A-3B, the base station antenna 200 includes four arrays of radiating elements, namely first and second mid-band arrays 220-1, 220-2 of mid-band radiating elements 222 and first and second high-band arrays 230-1, 230-2 of high-band radiating elements 232. Both the mid-band radiating elements 222 and the high-band radiating elements 232 may be implemented using dual-polarized radiating elements. The mid-band radiating elements 222 may be configured to transmit and receive RF signals in some or all of the 1427-2690 MHz frequency band (e.g., the 1695-2690 MHz frequency range). The high-band radiating elements 232 may be configured to transmit and receive RF signals in some or all of the 3.1-4.2 GHz frequency band (e.g., the 3.7-4.0 GHz frequency range). The arrays 220, 230 are mounted in between the backplane 210 and the RF lens 240, with the radiating elements extending forwardly from the backplane 210. In some embodiments, a length of the cylindrical RF lens 240 may be at least as long as the lengths of the linear arrays 220, 230 as shown in FIG. 3A. The radiating elements 222, 232 of each of the mid-band and high-band arrays 220, 230 are positioned to transmit and receive RF energy through the RF lens 240.

The first polarization radiator of each mid-band radiating element 222 in the first mid-band array 220-1 may be coupled to the first RF port 270-1, and the second polarization radiator of each mid-band radiating element 222 in the first mid-band array 220-I may be coupled to the second RF port 270-2. The first polarization radiator of each mid-band radiating element 222 in the second mid-band array 220-2 may be coupled to the seventh RF port 270-7, and the second polarization radiator of each mid-band radiating element 222 in the second mid-band array 220-2 may be coupled to the eighth RF port 270-8. Similarly, the first polarization radiator of each high-band radiating element 232 in the first high-band array 230-1 may be coupled to the third RF port 270-3, the second polarization radiator of each high-band radiating element 232 in the first high-band array 230-1 may be coupled to the fourth RF port 270-4, the first polarization radiator of each high-band radiating element 232 in the second high-band array 230-2 may be coupled to the fifth RF port 270-5, and the second polarization radiator of each high-band radiating element 232 in the second high-band array 230-2 may be coupled to the sixth RF port 270-6.

Each mid-band array 220 includes five mid-band radiating elements 222 that are arranged in a vertically-extending column. The mid-band radiating elements 222 of the first mid-band array 220-1 are mounted to extend forwardly from the first panel 212-1 of backplane 210 and the mid-band radiating elements 222 of the second mid-band array 220-2 are mounted to extend forwardly from the second panel 212-2 of backplane 210.

FIG. 3C illustrates a “building block” 202 which comprises one mid-band radiating element 222 and five high-band radiating elements 232. Each pair of arrays 220, 230 that are mounted on a panel 212 of the reflector includes at least one of the building blocks 202 (and in the particular embodiment of FIG. 3A, each pair of arrays 220, 230 includes five of the building blocks 202). In particular, as shown in FIGS. 3A and 3C, each high-band array 230 includes twenty-five high-band radiating elements 232 that are arranged in three vertically-extending columns 234-1, 234-2, 234-3 (see FIG. 3C). The high-band radiating elements 232 of the first high-band array 230-1 are mounted to extend forwardly from the first panel 212-1 of backplane 210 and the high-band radiating elements 232 of the second high-band array 230-2 are mounted to extend forwardly from the second panel 212-2 of backplane 210. As can best be seen in FIG. 3C, each mid-band radiating element 222 is implemented as a box dipole radiating element. Box-dipole radiating elements are a known class of dual-polarized radiating elements that include two pairs of dipole arms that are arranged generally in a box shape (and hence a diamond or square is used in the figures to represent each box dipole radiating element). In some cases, each pair of dipole arms may have a corner shape (i.e., the two dipole arms extend away from each other at a 90° angle.

The first pair of dipole arms are excited together to emit RF radiation having a first polarization, and the second pair of dipole arms are excited together to emit RF radiation having a second polarization. It will be appreciated, however, that the mid-band radiating elements 222 may be implemented using other types of radiating elements such as, for example, cross-dipole radiating elements or patch radiating elements in other embodiments.

As shown in FIGS. 3A and 3C, five high-band radiating elements 232 may be mounted about each mid-band radiating element 222. For example, four of the high-band radiating elements 232 may surround the mid-band radiating element 222. The high-band radiating elements 232 may comprise, for example, dipole, patch or any other appropriate radiating elements. In the depicted embodiment, each high-band radiating element 232 is implemented as a pair of cross-polarized radiating elements that each have a first polarization dipole radiator that emits RF radiation with a +45 degrees polarization and a second dipole radiator that emits RF radiation with a −45 degrees polarization. An X-shape is used in the figures to represent cross-dipole radiating elements.

In the depicted embodiment, the high-band radiating elements 232 are disposed in three vertically-extending columns 234, with two high-band radiating elements 232 in each of the outer columns 234 and a single high-band radiating element 232 in the middle column 234. Each array 230 includes five sub-arrays 238 of high-band radiating elements 232, with each sub-array 238 including five high-band radiating elements 232 Four of the five high-band radiating elements 232 in each sub-array 238 form a rectangle (here a square) that surrounds an associated one of the mid-band radiating elements 222. The fifth high-band radiating element 232 in each sub-array 238 is disposed in the middle of the square inside the interior of the associated mid-band box-dipole radiating element 222.

As shown in FIG. 3A, the base station antenna 200 includes a total of six vertically extending columns 234 of high-band radiating elements 232, namely columns 234-1 through 234-3 of the first high-band array 230-1 and columns 234-1 through 234-3 of the second high-band array 230-2. The third column 234-3 of the first high-band array 230-1 and the first column 234-1 of the second high-band array 230-2 are positioned in between the first mid-band array 220-1 and the second mid-band array 220-2.

In some embodiments, a phase center of the four high-band radiating elements 232 in each sub-array 238 that form/define the above-described rectangle (or the phase center of all five high-band radiating elements 232 of the sub-array 238) is aligned with a phase center of the mid-band radiating element 222 that is within the rectangle in at least one of the azimuth plane and the elevation plane. In some embodiments, the phase center of the four high-band radiating elements 232 in each sub-array 238 that form/define the above-described rectangle (or all five high-band radiating elements 232 of the sub-array 238) is aligned with the phase center of the mid-band radiating element 222 that is within the rectangle in both the azimuth plane and the elevation plane. Aligning the phase centers of each mid-band radiating element 222 with the phase center of the high-band radiating elements 232 that form the sub-arrays 238 that are associated with the mid-band radiating element 222 ensures that the “element” antenna beam emitted by the mid-band radiating element 222 will point in the same direction as the antenna beam formed by the sub-array 238 of high-band radiating elements 232.

The multiband, multibeam, sector-splitting base station antenna 200 can simultaneously generate four mid-band antenna beams 226 and four high-band antenna beams 236. The first and second mid-band antenna beams 226 may be a +45° linear polarization antenna beam and a −45° linear polarization antenna beam, each of which may have an azimuth HPBW of about 27-35° and a pointing direction of about −30° in the azimuth plane. The third and fourth mid-band antenna beams 226 may be a +45° linear polarization antenna beam and a −45° linear polarization antenna beam, each of which may have an azimuth HPBW of about 27-350 and a pointing direction of about +30° in the azimuth plane. The first and second high-band antenna beams 236 may be a +45° linear polarization antenna beam and a−45° linear polarization antenna beam, each of which may have an azimuth HPBW of about 27-35° and a pointing direction of about −30° in the azimuth plane. The third and fourth high-band antenna beams 236 may be a +45° linear polarization antenna beam and a −45° linear polarization antenna beam, each of which may have an azimuth HPBW of about 27-35° and a pointing direction of about +30° in the azimuth plane. Each of the above-described antenna beams 226, 236 may comprise a static antenna beam that is configured to provide service to a 60° sub-sector of the 120° sector served by base station antenna 200. Notably, the base station antenna 200 is configured to generate the same number of antenna beams in both the mid-band and high-band frequency ranges and to divide the 120° sector into the same number of sub-sectors (two) at both mid-band and high-band.

FIG. 3D schematically illustrates how the lensed base station antennas according to embodiments of the present invention may generate antenna beams at two different frequency bands that have approximately the same azimuth HPBW after the RF radiation in each frequency band is transmitted through the RF lens 240. FIG. 3D is a top view of the RF lens and one of the panels 212-1 of the backplane 210. As shown in FIG. 3D. one of the mid-band linear arrays 220 generates a first antenna beam 226 that has a main lobe that is wider than the RF lens 240. For example, 85% to 93% of the energy of the main lobe of the first antenna beam 226 may impinge on the RF lens 240. The RF lens 240 acts to focus the mid-band radiation that passes through the RF lens 240 to generate an antenna beam (as it exits the RF lens 240) having a first azimuth HPBW. One of the multicolumn high-band arrays 230 generates a second antenna beam 236 that also has a main lobe. Since the high-band array 230 has multiple columns of high-band radiating elements 232, and hence a larger aperture in the azimuth plane than the mid-band linear array 220, the second antenna beam 236 that is generated by the high-band array 230 has a narrower azimuth HPBW than does the first antenna beam 226 that is generated by the mid-band linear array 220. Consequently, almost all or all of the energy of the main lobe of the second antenna beam 236 may impinge on the RF lens 240, and the majority of this energy will only pass through a central portion of the RF lens 240. Consequently, the second antenna beam 236 under-illuminates the RF lens 240 (i.e., most of all of the main lobe of the second antenna beam 236 may pass through the RF lens 240, with the majority of the RF radiation passing through a central portion of the RF lens 240). As a result, a first percentage of a main lobe of the first antenna beam 226 (e.g., 90% of the RF energy) will illuminate the RF lens 240 and a second percentage of a main lobe of the second antenna beam 236 (e.g., 98%) will illuminate the RF lens 240, where the second percentage exceeds the first percentage. In example embodiments, the second percentage may exceed the first percentage by 2, 5, 8 or 10 or more percentage points (in the above example the second percentage exceeds the first percentage by 8 percentage points). As such, less of the RF lens material acts to focus the second antenna beam 236. Thus, while the RF lens 240 will, all things being equal, focus the second antenna beam 236 more than the first antenna beam 226 due to the difference in frequency, since the RF lens 240 appears as a smaller lens to the second antenna beam 236, the base station antenna 200 can be designed so that both the first antenna beam 226 and the second antenna beam 236 will have approximately the same azimuth HPBW when exiting the RF lens 240. Thus, by using larger aperture (in the azimuth plane) higher frequency arrays, a lensed multibeam antenna may be provided that generates the same number of antenna beams at two different frequency bands.

Typically, in a lensed base station antenna the maximum antenna gain is achieved when most of the main lobe of the antenna beam illuminates the RF lens. Thus, for example, the portion of the antenna beam that has a gain that is 10-15 dB below the peak gain of the antenna beam passes through the RF lens, For a cylindrical RF lens, this means that portions of the main lobe of the antenna beam that have gains that are less than 10-15 dB of the peak gain will not pass through the RF lens but instead will pass to the outer sides of the RF lens. As discussed above, according to the techniques of embodiments of the present invention, the higher frequency band antenna beams may under-illuminate the RF lens.

It will be appreciated that the base station antenna 200 may include a number of additional components that are not shown in FIGS. 3A-3D so as to focus on certain aspects of the invention. These additional elements may include, for example, a radome, top and bottom end caps, and various mechanical and electronic components such as remote electrical tilt units, mechanical linkages, controllers, filters, cables, phase shifters and the like that may be mounted behind the backplane 210. Such elements are conventional and known to those of skill in the art and hence will not be discussed further herein.

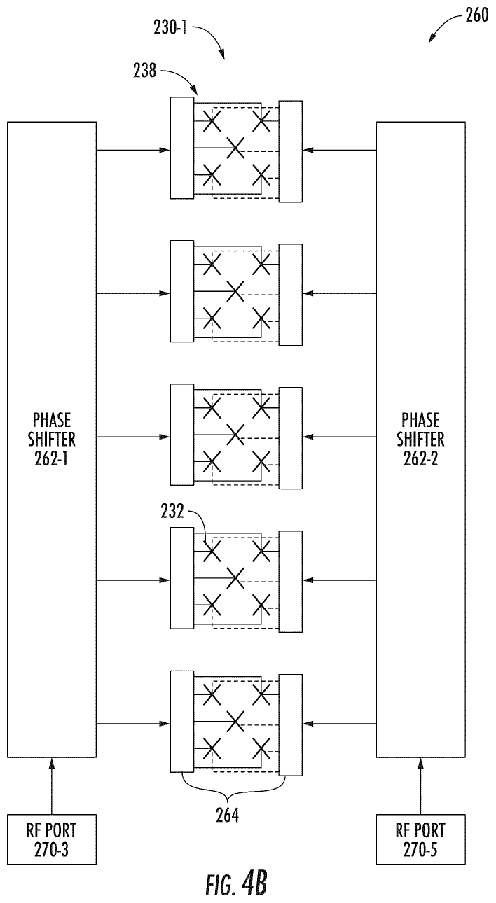

FIG. 4A is a schematic block diagram of a mid-band feed network 250 of base station antenna of FIGS. 3A-3C that connects the first (+45° polarization) RF port 270-1 and the second (−45° polarization) RF port 270-2 to the first mid-band array 220-1. A second, identical mid-band feed network 250 may be used to connect the seventh (+45° polarization) RF port 270-7 and the eighth (−45° polarization) RF port 270-8 to the second mid-band array 220-2.

As shown in FIG. 4A, the first RF port 270-1 is coupled to a first mid-band phase shifter 252-1. The first mid-band phase shifter 252-1 includes a power divider that divides RF signals input thereto into five-sub-components, and a phase shifting component that applies a phase progression across the five sub-components of the RF signal in order to impart a desired amount of electronic downtilt to the antenna beams generated in response to RF signals input at RF port 270-1, in a manner well understood by those of skill in the art. The outputs of the first phase shifter 252-1 are coupled to the +45° dipole radiators of the respective mid-band radiating elements 222 in the first mid-band array 220-1. Similarly, the second RF port 270-2 is coupled to a second mid-band phase shifter 252-2 that includes a power divider that divides RF signals input thereto into five-sub-components and a phase shifting component that applies a phase progression across the five sub-components of the RF signal in order to impart a desired amount of electronic downtilt to the antenna beams generated in response to RF signals input at RF port 270-2. The outputs of the second phase shifter 252-2 are coupled to the −45° dipole radiators of the respective mid-band radiating elements 222 in the first mid-band array 220-1. The azimuth HPBW of the antenna beams generated by the first mid-band array 220-1 may be about 65°. This antenna beam then passes through the RF lens 240 that acts to narrow the azimuth HPBW of each antenna beam to about 33°. The first mid-band linear array 220-1 is mounted on a panel 212-1 of the reflector that is angled so that the antenna beams 226 generated by the first mid-band linear array 220-1 will have an azimuth boresight pointing direction of about 30°.

FIG. 4B is a schematic block diagram of a high-band feed network 260 of base station antenna of FIGS. 3A-3C that connects the third (+45° polarization) RF port 270-3 and the fourth (−45° polarization) RF port 270-4 to the first high-band array 230-1. A second, identical high-band feed network 260 may be used to connect the fifth (+45° polarization) RF port 270-5 and the sixth (−45° polarization) RF port 270-6 to the second high-band array 230-2.

As shown in FIG. 4B, the third RF port 270-3 is coupled to a first high-band phase shifter 262-1. The first high-band phase shifter 262-1 includes a power divider that divides RF signals input thereto into five-sub-components and a phase shifting component that applies a phase progression across the five sub-components of the RF signal in order to impart a desired amount of electronic downtilt to the antenna beams generated in response to RF signals input at RF port 270-3. Each output of the first high-band phase shifter 262-1 is coupled to the +45° dipole radiators of the high-band radiating elements 232 in a respective one of the sub-arrays 238 of the first high-band array 230-1. Similarly, the fifth RF port 270-5 is coupled to a second high-band phase shifter 262-2 that includes a power divider that divides RF signals input thereto into five-sub-components and a phase shifting component that applies a phase progression across the five sub-components of the RF signal in order to impart a desired amount of electronic downtilt to the antenna beams generated in response to RF signals input at RF port 270-5. Each output of the second high-band phase shifter 262-2 is coupled to the −45° dipole radiators of the high-band radiating elements 232 in a respective one of the sub-arrays 238 of the first high-band array 230-1. The azimuth HPBW of the antenna beam 236 generated by the first high-band array 230-1 may be substantially less than 65° but more than 33°. This antenna beam 236 then passes through the RF lens 240 that acts to narrow the azimuth HPBW of the antenna beam 236 to about 33°. The first high-band linear array 230-1 is mounted on the first panel 212-1 so that the antenna beams 236 generated by the first high-band linear array 230-1 will have an azimuth boresight pointing direction of about 30°.

As described above, the lensed base station antennas according to embodiments of the present invention include arrays of higher frequency band radiating elements that are designed to under-illuminate the RF lens. As a result, the RF lens does not focus the higher frequency band RF energy as much as it would if the entire RF lens was illuminated. This technique allows an antenna designer to configure the base station antenna to generate a desired number of antenna beams in multiple different frequency bands. As described above, one way to have the arrays of higher frequency band radiating elements under-illuminate the RF lens is to implement these arrays as multicolumn arrays of radiating elements that have an expanded aperture in the azimuth plane. The base station antenna 200 of FIGS. 3A-3D illustrates one example multicolumn array design that can be used in the base station antennas according to embodiments of the present invention. It will be appreciated, however, that a wide variety of different array layouts may be used.

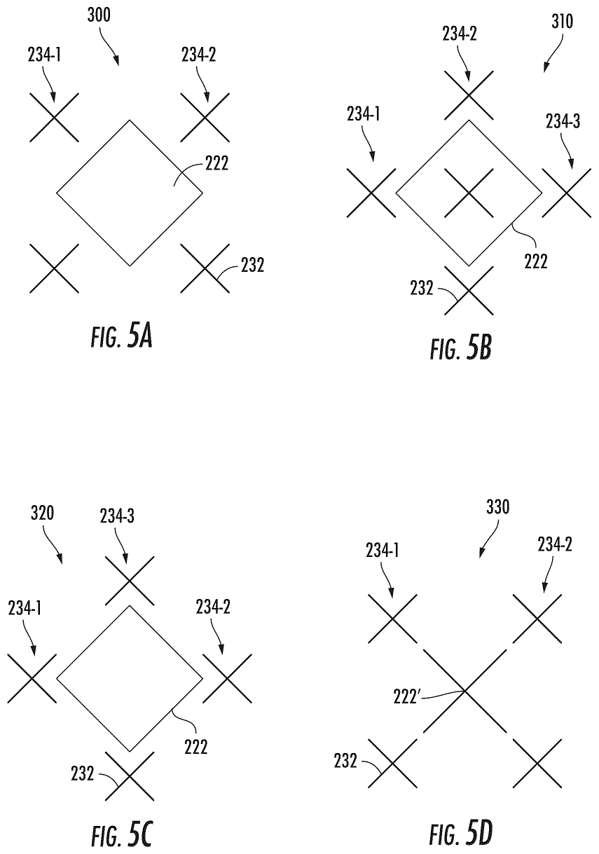

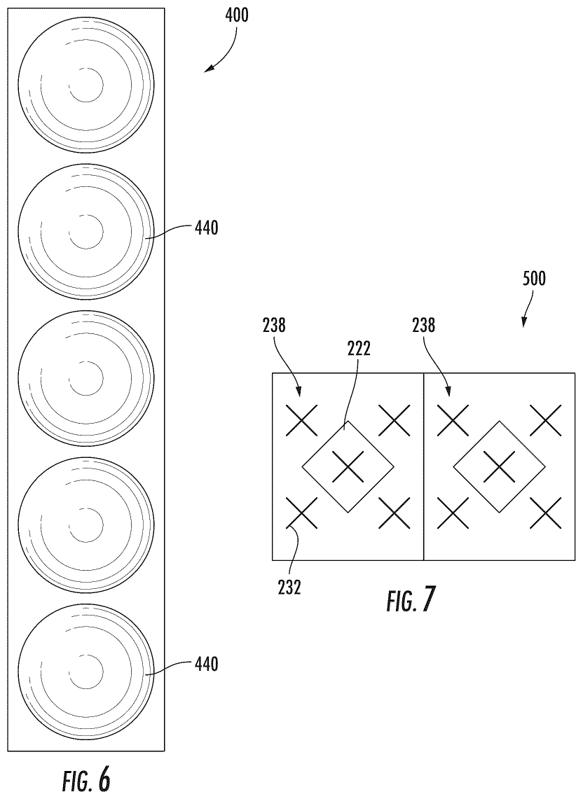

FIGS. 5A-5D are schematic front views of alternative sub-array configurations that can be used in place of the sub-array configuration for the high-band radiating elements used in the base station antenna of FIGS. 3A-3C. The base station antennas according to embodiments of the present invention may include a single row of the sub-array configurations shown in FIGS. 5A-5D or may include multiple rows of these sub-array configurations in the same manner that the base station antenna of FIGS. 3A-3C includes five rows of the sub-arrays 238. The sub-arrays shown in FIGS. 5A-5D may be used in place of the sub-arrays 238 included in base station antenna 200 of FIGS. 3A-3D.

Referring first to FIG. 5A, a sub-array 300 is shown that includes four high-band radiating elements 232 that are arranged in a rectangle to surround a mid-band radiating element 222. The sub-array 300 thus comprises two columns 234-1, 234-2 of high-band radiating elements 232. The sub-array 300 is identical to the sub-array 238 shown in FIG. 3C except that the fifth (central) high-band radiating element 232 is omitted in the sub-array 300.

Referring next to FIG. 5B, a sub-array 310 is shown that includes five high-band radiating elements 232 that are arranged in a rectangle to surround a mid-band radiating element 222. The sub-array 300 thus comprises three columns 234-1 through 234-3 of high-band radiating elements 232, just like the sub-arrays 238 of the base station antenna 200 of FIGS. 3A-3D. The sub-array 310 is identical to the sub-array 238 shown in FIG. 3C except that the four high-band radiating element 232 that surround the mid-band radiating element 222 are arranged above, below and to either side of the mid-band radiating element 222 instead of being arranged at the four corners of the mid-band radiating element 222. As such, the rectangle defined by the four outer high-band radiating elements 232 is rotated by 45° with respect to the rectangle defined by the four outer high-band radiating elements 232 included in the sub-array 238.

Referring next to FIG. 5C, a sub-array 320 is shown that includes four high-band radiating elements 232 that are arranged in the same fashion as the outer four high-band radiating elements included in sub-array 310 of FIG. 5B. The sub-array 300 thus comprises three columns 234-1 through 234-3 of high-band radiating elements 232. The sub-array 320 is identical to the sub-array 310 shown in FIG. 5B except that the fifth (central) high-band radiating element 232 is omitted in the sub-array 320.

Referring next to FIG. 5D, a sub-array 330 is shown that is identical to the sub-array 300 of FIG. 5A. The only difference between the designs of FIGS. 5A and 5D is that the box dipole mid-band radiating element 222 shown in FIG. 5A is replaced in FIG. 5D with a cross-dipole radiating element 222′ in sub-array 330.

The number and positioning of the high-band radiating elements 232 in each sub-array impacts the azimuth HPBW of the antenna beams generated by the high-band arrays 230. For example, all else being equal (e.g., column spacing, the amount of RF energy fed to each radiating element, etc.), the sub-array 238 of FIG. 3C will generate antenna beams having narrower azimuth HPBWs than the sub-array 310 of FIG. 5B, since sub-array 238 has four radiating elements 232 in the outer columns 234-1, 234-3, while sub-array 310 only has two radiating elements 232 in the outer columns 234-1, 234-3. The azimuth HPBW may be further adjusted by adjusting the “taper” of the RF energy fed to radiating elements in inner columns versus outer columns of the sub-array. Specifically, by increasing the percentage of the RF energy fed to radiating elements in the outer columns 234-1, 234-3 the azimuth HPBW may be further narrowed, whereas by increasing the percentage of the RF energy fed to radiating elements in the inner column 234-2 the azimuth HPBW may be increased.

It will be appreciated that the sub-arrays 300, 310, 320, 330 of FIGS. 5A-5D may be used in place of the sub-array 238 in any of the base station antennas according to embodiments of the present invention. It will also be appreciated that any other sub-array designs may be used that generate narrower antenna beams in the higher frequency band than are generated in the lower frequency band.

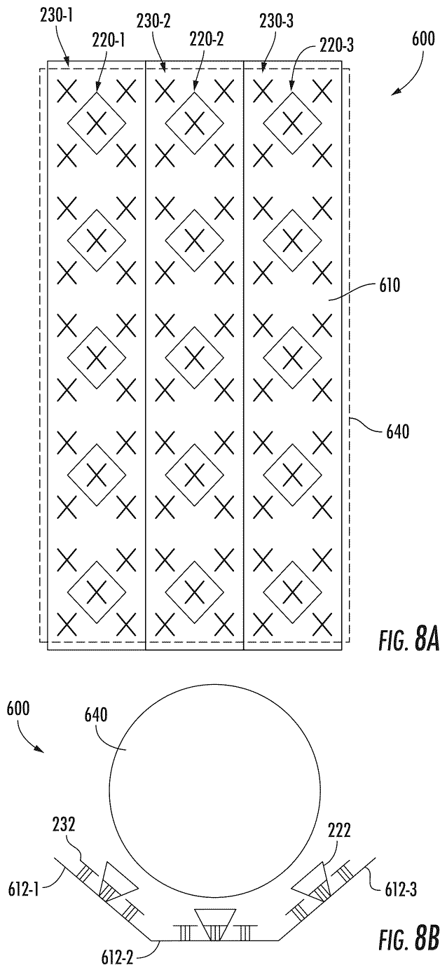

FIG. 6 is a schematic front view of a base station antenna 400 according to further embodiments of the present invention. The base station antenna 400 may be identical to base station 200 of FIGS. 3A-3D, except the cylindrical RF lens 240 of base station 200 is replaced in base station 400 with a column of spherical RF lenses 440. Replacing the cylindrical RF lens 240 with a column of spherical RF lenses 440 may reduce the overall size and weight of the base station antenna 400.

As discussed above, the base station antenna 200 includes arrays that comprise columns of radiating elements 222, 232. By adding more radiating elements 222, 232 to the mid-band and high-band arrays 220, 230 the overall length of the arrays 220, 230 may be extended without generating excessive grating lobes or other performance degradations that occur if adjacent radiating elements in a column are spaced too far apart. In the base station antenna 200 of FIGS. 3A-3D, each mid-band array 220 included a vertically-extending column of five mid-band radiating elements 222, and each high-band array 230 included a vertically-extending column of five sub-arrays 238 of high-band radiating elements 232, where each sub-array 238 included five high-band radiating elements 232 that are arranged in three columns 234. As a result, the two outer columns 234-1, 234-3 in each high-band array 230 include ten high-band radiating elements 232 and the inner column 234-2 in each high-band array 230 includes five high-band radiating elements 232.

It will be appreciated that the number of radiating elements 222 and/or sub-arrays 238 in each column 234 can be varied, either together or independently. For example, in other embodiments each mid-band array 220 may include five mid-band radiating elements 222 while each high-band array 230 may include four or less or six or more sub-arrays 238. It will also be appreciated that in some embodiments, each mid-band array 220 may include a single mid-band radiating elements 222, and each high-band array 230 may include a single sub-array 238 of high-band radiating elements 232. FIG. 7 is a schematic front view of a multiband, multibeam lensed antenna 500 with the radome and RF lens removed that has this design. As shown, the base station antenna 500 includes a single row of mid-band radiating elements 222, and three rows of high-band radiating elements 232 (since each sub-array 238 includes three rows of high-band radiating elements 232). Thus, in the embodiment of FIG. 7, each mid-band array 220 includes a single mid-band radiating element 222, and each high-band array 230 includes a single sub-array of radiating elements, where the sub-array has five high-band radiating elements 232.

FIG. 8A is a schematic front view of a multiband, tri-beam lensed base station antenna 600 according to further embodiments of the present invention with the radome removed and an RF lens 640 of the base station antenna 600 shown in shadow view. FIG. 8B is a schematic end view of the multiband, tri-beam lensed base station antenna 600 of FIG. 8A.

The base station antenna 600 is similar to the base station antenna 200 of FIGS. 3A-3D, with the primary difference being that base station antenna 600 includes three mid-band arrays 220-1 through 220-3 and three multicolumn high-band arrays 230-1 through 230-3. The reflector 610 of base station antenna 600 also includes three panels 612-1 through 612-3, with a respective one of the mid-band arrays 220 and a respective one of the high-band arrays 230 mounted to extend forwardly from each panel 612-1 through 612-3.

Adjacent panels 612 meet at angles of about 140° so that each antenna beam that is formed by base station antenna 600 will point to the center of a respective one of three 40° sectors that are centered at about −40°, 0° and 40° in the azimuth plane, respectively. FIGS. 8A-8B show that the concepts disclosed herein may be used with base station antennas that generate any number of antenna beams.

FIG. 9 is a schematic front view of a sector-splitting multiband, multibeam lensed base station antenna 700 with the radome removed that splits a sector into six sub-sectors. The base station antenna 700 is similar to the base station antenna 200 of FIGS. 3A-3D, except that base station antenna 700 includes six mid-band arrays 220 and six high-band arrays 230 and a backplane 710 that includes six panels 712-1 through 712-6 that are angled so that each array 220, 230 points in the proper direction to provide coverage to the six respective sub-sectors. As noted above, when a 120° sector is split into a larger number of sub-sectors (e.g., three or more), it may be advantageous to use a Luneberg lens to split the sector. The RF lens 740 included in base station antenna 700 may, for example, be a cylindrical Luneberg lens that has a diameter of, for example, between 800-950 mm. In one example embodiment, the RF lens 740 may be a five-step approximation of a Luneberg lens, where the RF lens 740 may have annular regions having dielectric constants of 1.9, 1.77, 1.6, 1.37 and 1.1, and the outer edge of these regions have radiuses of 150 mm, 225 mm, 300 mm, 375 mm and 450 mm, respectively. Since other aspects of base station antenna 700 are similar to base station antenna 200 of FIGS. 3A-3D, further description of the base station antenna 700 will be omitted here. It should be noted that while the base station antenna 700 is illustrated as including a single cylindrical RF lens 740, in other embodiments antenna 700 may include a plurality of smaller (shorter) cylindrical RF lens that are stacked or may include a plurality of stacked spherical RF lens. Other shaped lenses may also be used.

It will be appreciated that the above embodiments are just examples, and that that base station antennas according to embodiments of the present invention can split a sector into any appropriate number of sub-sectors. Base station antenna 200 provides an example of a so-called twin beam antenna (i.e., it generates two antenna beams per polarization for each frequency band) that is used to split a sector into two sub-sectors, while base station antenna 600 provides an example of a tri-beam antenna (i.e., it generates three antenna beams per polarization for each frequency band) that is used to split a sector into three sub-sectors. Base station 700 illustrates an example of a multiband base station antenna that divides a sector into six sub-sectors in each of two frequency bands. It will be appreciated that in other embodiments, base station antennas may be provided that generate four, five, or seven or more antenna beams per polarization for each frequency band that split a sector into four, five, or seven or more sub-sectors.

FIG. 10 is a schematic front view of a multiband, multibeam lensed base station antenna 800 according to further embodiments of the present invention. The base station antenna 800 illustrates that the same techniques that are discussed above may be used to provide base station antennas that have different numbers of sub-sectors per frequency band. As discussed above, conventionally a lensed multiband base station antenna will have a different number of sub-sectors for each frequency band, where the ratio of number of sub-sectors provided in the higher frequency band to the number of sub-sectors provided in the lower frequency band is approximately equal to the ratio of the center wavelength of the higher frequency band to the center wavelength of the lower frequency band. Pursuant to embodiments of the present invention, base station antennas are provided that divide a sector into different number of sectors at each frequency band where the difference in the number of sectors does not correspond to the ratio of center wavelengths of the two frequency bands.

Referring to FIG. 10, the base station antenna 800 includes three arrays 220 of mid-band radiating elements 222 and five arrays 230 of high-band radiating elements. The mid-band radiating elements 222 are configured to operate in 1427-2200 MHz frequency band, while the high-band radiating elements 232 are configured to operate in the 3.7-4.0 GHz frequency band. Thus, the ratio of the center frequencies (and hence the ratio of the center wavelengths) of the two frequency bands is 1814/3850=0.47 or ≈0.5, which means that the number of sub-sectors at high-band should be twice the number of sub-sectors at mid-band if conventional techniques are used. The base station antenna 800, however, is configured to divide the sector into five sub-sectors at high-band and three sub-sectors at mid-band, which is a ratio of 5:3 as opposed to a ratio of 2:1 (or equivalently 6:3). Thus, the base station antenna 800 illustrates how the techniques disclosed herein can be used to independently select the number of sub-sectors at each frequency band.

In another example embodiment, a dual-band multibeam base station antenna is provided that generates three antenna beams (per polarization) at low-band (e.g., 617-894 MHz) and six antenna beams (per polarization) at mid-band (e.g., 1695-2690 MHz). Notably, the ratio of the center frequencies of the two frequency bands is about 2200/750 which is a ratio of about 3:1, but the ratio of the number of sub-sectors is 2:1. This technique can be applied over a wide variety of additional pairs of frequency bands including, for example, the 3.5 GHz and 4.9 GHz frequency bands, the 3.5 GHz and 5.8 GHz frequency bands, and the 2.4 GHz and 5.8 GHz frequency bands.

While the above-described embodiments of the present invention are all dual-band base station antennas, it will be appreciated that embodiments of the present invention are not limited thereto. For example, the same techniques can be used in tri-band antennas that include linear arrays of radiating elements that operate in three different frequency bands. FIG. 11 is a schematic front view of a portion of a tri-band base station antenna according to embodiments of the present invention. In particular, FIG. 11 illustrates a building block 902 that includes a low-band radiating element of a first low-band array of the base station antenna, a sub-array of a first mid-band array of the base station antenna, and a sub-array of a first high-band array of the base station antenna.

As shown in FIG. 11, the mid-band sub-array has the same design as the sub-array 300 of FIG. 5A with four second frequency-band radiating elements 232 that are arranged in two columns 234-1, 234-2 to surround a single first frequency-band radiating element 222. In addition, sixteen third frequency band radiating elements 982 are provided that are arranged in four columns 984-1 through 984-4. In the example of FIG. 11, the first frequency band may be the low-band, the second frequency band may be the mid-band, and the third frequency band may be the high-band. The building block 902 shown in FIG. 11 may be repeated in the horizontal direction and/or vertical direction to form a multiband, multibeam base station antenna. The building block 902 may be repeated in the horizontal direction a first number of times, where the first number corresponds to a desired number of sub-sectors. The building block 902 may be repeated in the vertical direction to meet elevation beamwidth and/or gain requirements for the antenna 900.

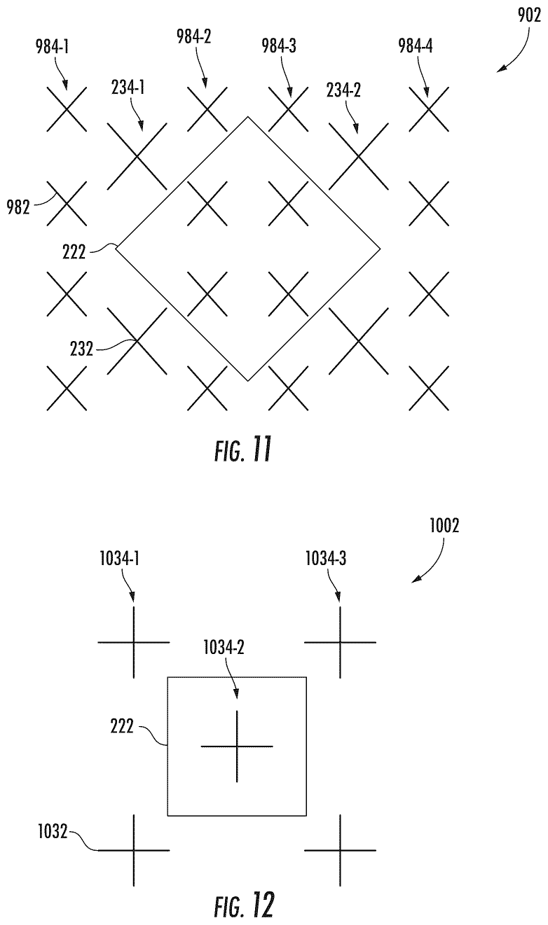

FIG. 12 is a front view of a building block 1002 of a multiband base station antenna according to still further embodiments of the present invention. The building block 1002 is similar to the building block 202 of FIG. 3C, except that the box dipole radiating element 222 included in building block 1002 is rotated 45° as compared to the box dipole radiating element 222 included in building block 202. Additionally, in As shown in building block 1002, the +/−45° cross-dipole high-band radiating elements 232 that re included in building block 202 are replaced with vertical/horizontal cross-dipole high-band radiating elements 1032. Both building blocks 202 and 1002 will exhibit good isolation between the mid-band and high-band radiating elements due to the relative orientations of the cross-dipole and box-dipole radiating elements.

Numerous modifications may be made to the above-described antennas without departing from the scope of the present invention. For example, in some embodiments of the present invention, the lower frequency band radiating elements are implemented as box dipole radiating elements so that the higher frequency band radiating element may be mounted within the lower frequency-band radiating element. It will be appreciated that radiating elements other than box dipole radiating elements are known in the art that similarly have an open interior. As one example, U.S. Pat. No. 8,674,895 discloses a base station antenna that includes low-band microstrip annular ring radiating elements that have cross-dipole radiating elements mounted within an interior thereof.

In the example embodiments discussed above, the base station antennas are used to split 120° sectors in the azimuth plane into a plurality of sub-sectors. It will be appreciated that in other embodiments the base station antennas according to embodiments of the present invention may split sectors having different sizes in the azimuth plane (e.g., 75°, 90°, 100°, 140°, etc.) into a plurality of sub-sectors

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

Terms such as “top,” “bottom,” “upper,” “lower,” “above,” “below,” and the like are used herein to describe the relative positions of elements or features. For example, when an upper part of a drawing is referred to as a “top” and a lower part of a drawing is referred to as a “bottom” for the sake of convenience, in practice, the “top” may also be called a “bottom” and the “bottom” may also be a “top” without departing from the teachings of the inventive concept.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

The terminology used herein to describe embodiments of the invention is not intended to limit the scope of the inventive concept.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A multiband base station antenna, comprising:
a first radio frequency (“RF”) port;
a second RF port;
a third RF port;
a fourth RF port;
an RF lens;
a reflector having at least first and second panels that are angled with respect to each other;
a first lower frequency band array mounted on the first panel and coupled to the first RF port, the first lower frequency band array including a first lower frequency band radiating element that is positioned to transmit RF signals through the RF lens;
a second lower frequency band array mounted on the second panel and coupled to the second RF port, the second lower frequency band array including a second lower frequency band radiating element that is positioned to transmit RF signals through the RF lens;
a first higher frequency band array mounted on the first panel and coupled to the third RF port, the first higher frequency band array including a first plurality of higher frequency band radiating elements that are positioned to transmit RF signals through the RF lens; and
a second higher frequency band array mounted on the second panel and coupled to the fourth RF port, the second higher frequency band array including a second plurality of higher frequency band radiating elements that are positioned to transmit RF signals through the RF lens,
wherein the first plurality of higher frequency band radiating elements are mounted in at least a first column and a second column and the second plurality of higher frequency band radiating elements are mounted in at least a third column and a fourth column.

2. The base station antenna of claim 1, wherein the base station antenna is a sector splitting antenna that is configured to generate static first and second lower frequency band antenna beams that point in different directions and static first and second higher frequency band antenna beams that point in different directions

3. (canceled)

4. The base station antenna of claim 1, wherein the second column and the third column are positioned in between the first lower frequency band array and the second lower frequency-band array.

5. The base station antenna of claim 1, wherein one of the higher frequency band radiating elements in the first plurality of higher frequency band radiating elements is mounted within an interior of the first lower frequency band radiating element.

6-7. (canceled)

8. The base station antenna of claim 1, wherein the first lower frequency band array is configured to generate a first antenna beam and the first higher frequency band array is configured to generate a second antenna beam, where the base station antenna is configured so that a first percentage of a main lobe of the first antenna beam illuminates the RF lens and a second percentage of a main lobe of the second antenna beam illuminates the RF lens, where the second percentage exceeds the first percentage.

9. The base station antenna of claim 1, wherein at least some of the higher frequency band radiating elements in the first plurality of higher frequency band radiating elements surround the first lower frequency band radiating element.

10. The base station antenna of claim 1, wherein a total of four of the higher frequency band radiating elements in the first plurality of higher frequency band radiating elements surround the first lower frequency band radiating element.

11. The base station antenna of claim 10, wherein a phase center of the four of the higher frequency band radiating elements in the first plurality of higher frequency band radiating elements that surround the first lower frequency band radiating element is aligned with a phase center of the first lower frequency band radiating element in at least one of the azimuth plane and the elevation plane.

12. The base station antenna of claim 10, wherein a phase center of the four of the higher frequency band radiating elements in the first plurality of higher frequency band radiating elements that surround the first lower frequency band radiating element is aligned with a phase center of the first lower frequency band radiating element in both the azimuth plane and the elevation plane.

13. (canceled)

14. The base station antenna of claim 1, wherein the first plurality of higher frequency band radiating elements are further mounted in a fifth column that is in between the first column and the second column.

15-31. (canceled)

32. A multiband, multibeam base station antenna, comprising:
one or more radio frequency (“RF”) lenses;
a plurality of first RF ports;
a plurality of second RF ports;
a plurality of arrays of first radiating elements, each array of first radiating elements coupled to a respective one of the RF ports in the plurality of first RF ports and including at least one first radiating element, where the first radiating elements are configured to operate in a first frequency band and are positioned to transmit RF signals through the one or more RF lenses; and
a plurality of arrays of second radiating elements, each array of second radiating elements coupled to a respective one of the RF ports in the plurality of second RF ports and including a plurality of second radiating elements, where the second radiating elements are configured to operate in a second frequency band and are positioned to transmit RF signals through the one or more RF lenses,
wherein a first number of arrays of first radiating elements is the same as a second number of arrays of second radiating elements, and
each of the arrays of second radiating elements is a multicolumn array of radiating elements.

33. The multiband, multibeam base station antenna of claim 32, wherein the second frequency band encompasses higher frequencies than the first frequency band.

34. The multiband, multibeam base station antenna of claim 33, wherein the base station antenna is configured to generate a first number of antenna beams in the first frequency band and to also generate the first number of antenna beams in the second frequency band.

35-36. (canceled)

37. The multiband, multibeam base station antenna of claim 32, wherein the second radiating elements in each of the plurality of arrays of second radiating elements are mounted to define at least first, second and third columns.

38-53. (canceled)

54. A multiband, multibeam base station antenna, comprising:
one or more radio frequency (“RF”) lenses;
a plurality of arrays of first radiating elements, each array of first radiating elements including at least one first radiating element, where the first radiating elements are configured to operate in a first frequency band and are positioned to transmit RF signals through the one or more RF lenses; and
a plurality of arrays of second radiating elements, each array of second radiating elements including a sub-array of second radiating elements that are positioned around one of the first radiating elements in a respective one of the plurality of arrays of first radiating elements, where the second radiating elements are configured to operate in a second frequency band that encompasses higher frequencies that the first frequency band and are positioned to transmit RF signals through the one or more RF lenses.

55. (canceled)

56. The multiband, multibeam base station antenna of claim 54, wherein at least some of the sub-arrays of second radiating elements includes a second radiating element that is positioned within the footprint of a respective one of the first radiating elements.

57. (canceled)

58. The multiband, multibeam base station antenna of claim 54, wherein the base station antenna is a sector-splitting base station antenna that is configured to sub-divide a coverage area of the base station antenna into a first number of sub-sectors in the first frequency band and to also sub-divide the coverage area of the base station antenna into the first number of sub-sectors in the second frequency band.

59. The multiband, multibeam base station antenna of claim 54, wherein each sub-array of second radiating elements includes at least four second radiating elements that are mounted to define at least first and second columns.

60. The multiband, multibeam base station antenna of claim 54, wherein each sub-array of second radiating elements includes at least five second radiating elements that are mounted to define at least first, second and third columns.

61. The multiband, multibeam base station antenna of claim 54, wherein each sub-array of second radiating elements includes at least four second radiating elements that are arranged to define a rectangle.
